(19) United States
(12) Patent Application Publication
(10) Pub. No.: US 2017/0032219 A1
(43) Pub. Date: Feb. 2, 2017

(54) METHODS AND DEVICES FOR PICTURE PROCESSING

(71) Applicant: Xiaomi Inc., Beijing (CN)

(72) Inventors: Tao ZHANG, Beijing (CN); Zhijun CHEN, Beijing (CN); Fei LONG, Beijing (CN)

(73) Assignee: Xiaomi Inc., Beijing (CN)

(21) Appl. No.: 15/092,032

(22) Filed: Apr. 6, 2016

(30) Foreign Application Priority Data
Jul. 31, 2015 (CN) 201510465211 . 7

(51) Int. Cl. G06K 9/62; G06K 9/46

(52) U.S. Cl. CPC G06K 9/6215; G06K 9/46

(57) ABSTRACT

Methods and devices are provided for processing picture in the field of terminal technology. In the method, the device scans a plurality of pictures in a picture directory in the memory storage during a process to manage the memory storage. The device generates at least one group of similar pictures according to an attribute of each picture and pre-extracted picture features of the each picture, where the attribute comprises at least a photographing time. The device displays pictures group by group. The device detects an operation on at least one picture and processing the at least one picture according to the detected operation.

### CROSS-REFERENCE TO RELATED APPLICATION

This application claims priority to Chinese Patent Application 201510465211.7 filed on Jul. 31, 2015, the entire content of which is incorporated herein by reference.

### TECHNICAL FIELD

The present disclosure generally relates to the field of information technology, and more particularly to a picture processing method and device.

### BACKGROUND

In modern life, to obtain a satisfactory picture, a user will generally use a mobile terminal to photograph same content for multiple times to obtain a plurality of pictures containing the same content. Since the pictures are of certain sizes, storing all the pictures in the terminal not only will take up terminal memory and impact terminal performance, but also will cause inconvenience to the user in viewing the pictures. Therefore, it is required to process pictures stored in the terminal.

At present, in picture processing according to related art, a user has to open an album application and recognize similar pictures in a picture directory with the naked eye; then the pictures are managed by detecting a user operation. A picture is deleted when it is detected that the user selects a delete option on the picture. A picture is saved when it is detected that the user selects a save option on the picture.

### SUMMARY

According to a first aspect of embodiments of the present disclosure, there is provided a picture processing method. In the method, a device scans a plurality of pictures in a picture directory in the memory storage during a process to manage the memory storage. The device generates at least one group of similar pictures according to an attribute of each picture and pre-extracted picture features of the each picture, where the attribute comprises at least a photographing time. The device displays pictures group by group. The device detects an operation on at least one picture and processing the at least one picture according to the detected operation.

According to a second aspect of embodiments of the present disclosure, there is provided a picture processing device, including: a processor; and a memory, configured for: storing an instruction executable by the processor. The processor may be configured to: scan a plurality of pictures in a picture directory in the memory during a process to manage the memory; generate at least one group of similar pictures according to an attribute of each picture and pre-extracted picture features of the each picture, wherein the attribute comprises at least a photographing time; display pictures group by group; and detect an operation on at least one picture and processing the at least one picture according to the detected operation.

According to a third aspect of embodiments of the present disclosure, there is provided a non-transitory computer-readable storage medium having stored therein instructions that, when executed by a processor, causes the mobile terminal to perform the picture processing method.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in the specification and constitute a part of this specification, illustrate embodiments consistent with the disclosure, and, together with the description, serve to explain the principles of the disclosure.

FIG. 1 is a flowchart of a picture processing method according to an exemplary embodiment;

FIG. 2 is a flowchart of a picture processing method according to an exemplary embodiment;

FIG. 3 is a schematic diagram of a memory space processing page according to an exemplary embodiment;

FIG. 4 is a schematic diagram of groups of similar pictures according to an exemplary embodiment;

FIG. 5A is a schematic diagram of groups of similar pictures according to an exemplary embodiment;

FIG. 5B is a schematic diagram of groups of similar pictures according to an exemplary embodiment;

FIG. 6 is a diagram of a structure of a device for processing similar pictures according to an exemplary embodiment; and

FIG. 7 is a block diagram of a picture processing device according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

The terminology used in the description of the disclosure herein is for the purpose of describing particular examples only and is not intended to be limiting of the disclosure. As used in the description of the disclosure and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

It should be understood, although elements may be described as terms first, second, third or the like in the present disclosure, the elements are not limited by these terms. Rather, these terms are merely used for distinguishing elements of the same type. For example, a first element can also be referred to as a second element, and similarly, a second element can also be referred to as a first element, without departing from the scope of the present disclosure. Depending on the context, as used herein, the word “if” can be interpreted as “at the time when”, “when” or “in response to.”

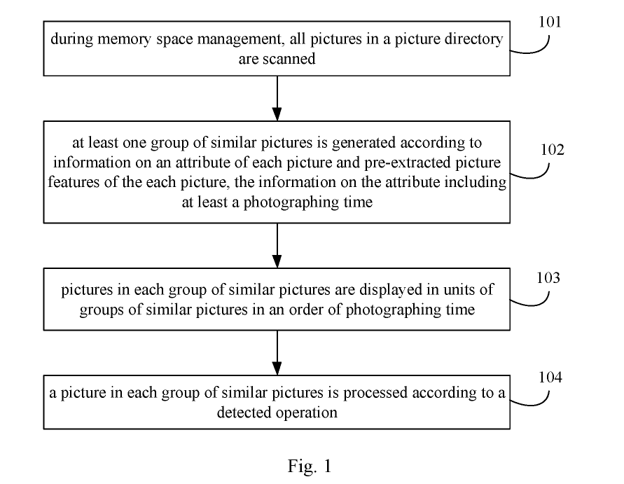

FIG. 1 is a flowchart of a picture processing method according to an exemplary embodiment. As shown in FIG. 1, the picture processing method is applied in a terminal device and includes steps as follows. The terminal device may include a smart phone, a mobile terminal, a camera device, or any device including a processor and a storage to store pictures.

In step 101, the terminal device scans a plurality of pictures in a picture directory in the memory storage during a process to manage the memory storage. For example, during memory space management, the device scans a plurality of pictures in a picture directory are scanned.

In step 102, the terminal device generates at least one group of similar pictures according to an attribute of each picture and pre-extracted picture features of the each picture, where the attribute comprises at least a photographing time. At least one group of similar pictures is generated according to information on an attribute of each picture and pre-extracted picture features of the each picture. The information on the attribute includes at least a photographing time.

In step 103, the terminal device displays pictures group by group. For example, pictures in each group of similar pictures may be displayed in units of groups of similar pictures in an order of photographing time.

In step 104, the terminal device detects an operation on at least one picture and processing the at least one picture according to the detected operation. For example, a picture in each group of similar pictures may be processed according to a detected operation.

With the method in the disclosure, a picture is grouped into a group of similar pictures according to attributes of the pictures such as photographing time and picture features of the pictures. The grouped pictures may then be displayed by groups of similar pictures according to the photographing time, thus facilitating processing, by a user, a picture in a group of similar pictures with a more convenient and less time consuming processing process.

According to one or more embodiments herein, the picture features may include a global feature and a local feature. The picture features may be pre-extracted by the terminal device when the picture is taken. Alternatively or additionally, the picture features may be pre-extracted by a cloud server when the picture is stored on the cloud storage.

At least one group of similar pictures may be generated according to the information on the attributes of the pictures and the pre-extracted picture features of the pictures as follows.

The pictures in the picture directory may be divided into groups of pictures according to the information on the attributes of the pictures. Each of the groups of pictures may include at least two pictures.

A similarity of global features of two pictures in a group of pictures and a similarity of local features of the two pictures may be computed.

When the similarity of the global features is greater than a first threshold, and the similarity of the local features is greater than a second threshold, a weighted result may be obtained by weighting the similarity of the global features and the similarity of the local features.

When the weighted result is greater than a third threshold, the two pictures may be set to be similar pictures that are similar to each other.

A group of similar pictures may be formed with a plurality of pictures similar to a same picture in the group of pictures.

According to one or more embodiments, a picture in a group of similar pictures may be processed according to a detected operation as follows. A save option and a delete option may be displayed on a picture of a group of similar pictures. When it is detected that a delete option on a picture is selected, the picture may be deleted. When it is detected that a save option on a picture is selected, the picture may be saved.

According to one or more embodiments, after a picture is deleted, a delete instruction may be sent to a server. The delete instruction may be configured for instructing the server to delete the picture in a cloud memory space.

According to one or more embodiments, the method may further include steps as follows. A picture management option may be displayed on a memory space management page. When it is detected that the picture management option is selected, a plurality of pictures in the picture directory may be scanned.

An optional embodiment herein may be formed by any combination of aforementioned acts disclosed above, which will not be repeated here. In other words, different embodiments may be combined to be implemented in a terminal.

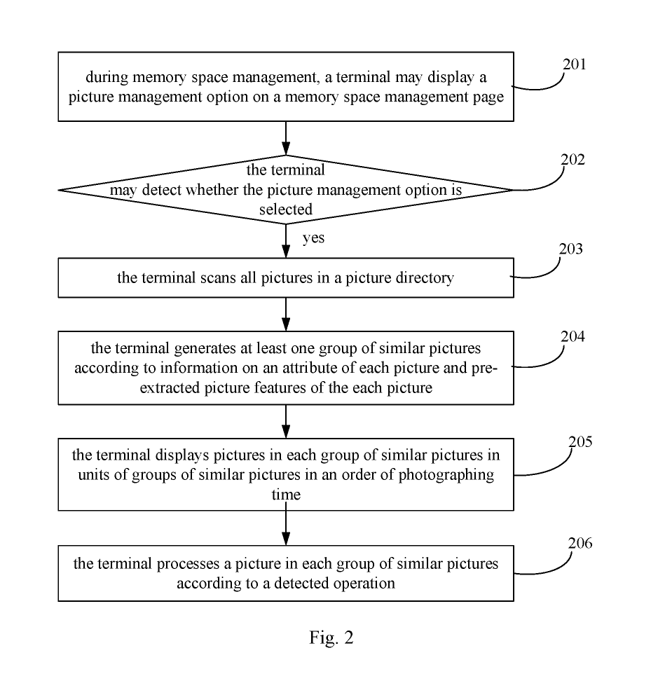

FIG. 2 is a flowchart of a picture processing method according to an exemplary embodiment. As shown in FIG. 2, the picture processing method is applied in a terminal, and may include steps as follows.

In step 201, during memory space management, a terminal may display a picture management option on a memory space management page.

A picture may be in various forms, such as that photographed by a camera, that snapshot by a snipping tool, and/or the like. The terminal may be a smart phone, a tablet computer, a desktop computer, and/or the like. The present embodiment does not limit a product type of the terminal. A camera may be installed in the terminal. The terminal may photograph various pictures using the installed camera. A snipping application for capturing a screenshot may be installed in the terminal. The terminal may intercept an image of a certain area on a screen or the whole screen and stores the intercepted image as a picture using the installed snipping application.

Generally, some junk data may be generated during operation of the terminal. Such junk information data occupy the memory space of the terminal, which is limited. Normal operation of the terminal will be affected when such junk data are not processed in time. In general, software will be installed in the terminal to manage, such as clean, the junk data generated during the operation of the terminal to ensure smooth operation of the terminal.

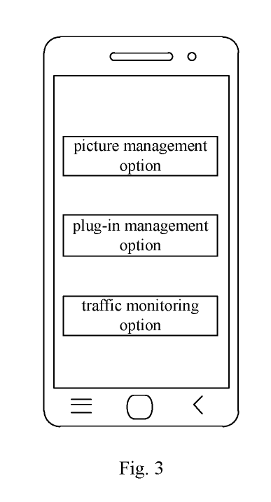

As shown in FIG. 3, during memory space management by running a managing software, the terminal may display multiple options including a picture management option, a plug-in management option, a traffic monitoring option, and/or the like on the memory space management page so as to manage, such as to remove, different types of junk data in the terminal.

In step 202, the terminal may detect whether the picture management option is selected. When it is selected, step 203 may be performed.

The terminal may detect whether the picture management option is selected in ways including but not limited to that as follows. A change in a pressure on the screen of the terminal may be detected using a built-in pressure sensor. When it is detected that a pressure on a certain position on the screen of the terminal changes, the terminal will obtain coordinates of the position, and compare the coordinates of the position with an area where the picture management option is located. When the position is within the area where the picture management option is located, it may be determined that the picture management option is selected.

The detection of a pressure change on the screen of the terminal is but one way in which the terminal may detect whether the picture management option is selected. In a practical application, the terminal may detect whether the picture management option is selected in other ways, which are not limited by the present embodiment.

In step 203, the terminal scans a plurality of pictures in a picture directory.

In one or more embodiments, the picture directory may be a specific directory in the terminal for storing a picture. A picture in the picture directory may be a picture taken by a camera, a picture snapshot by a snipping tool, a picture downloaded via a network connection, or a picture received from another terminal by turning on a Bluetooth function, an infrared function, etc. The form of a picture in the picture directory is not limited by the present embodiment.

When scanning the pictures in the picture directory, the terminal may preset a scanning sequence and scan the pictures in the picture directory one by one according to the scanning sequence. The preset scanning sequence may be the photographing time of the pictures, sizes of the pictures and/or the like. Taking the scanning sequence of the photographing time for example, in scanning the pictures in the picture directory, the terminal may perform the scanning in chronological order of the photographing time. For example, the terminal may perform the scan starting from a picture photographed first and in the end scan a picture photographed last. The scanning may also be performed in reverse chronological order. For example, the terminal may first scan a picture photographed last, and in the end scan a picture photographed first. The terminal may perform the scanning during a time period selected by the user.

In step 204, the terminal generates at least one group of similar pictures according to information on an attribute of each picture and pre-extracted picture features of the each picture.

By scanning the pictures in the picture directory in Step 203, the terminal may obtain information on an attribute of each picture, such as a photographing time when the picture is taken, a photographing location where the picture is taken, a size of the picture, a brightness of the picture, a contrast of the picture, a grey scale of the picture, and/or the like. Meanwhile, a feature extracting module built in the terminal may also extract picture features of each picture in the picture directory, and then form a feature file according to extracted picture features. A picture feature may include a global feature and a local feature, and/or the like. A local feature mainly describes a change in a detail of content of a picture, including Scale-Invariant Feature Transform (SIFT), Speed Up Robust Features (SURF), and/or the like. A global feature mainly describes an overall attribute of content of a picture, including a color distribution histogram, a texture histogram of Local Binary Patterns (LBP) and/or the like.

The terminal may generate at least one group of similar pictures according to the information on the attribute of each picture and the pre-extracted picture features of the each picture through steps 1˜3 as follows.

In step 1, the terminal may divide the pictures in the picture directory into groups of pictures according to the information on the attributes of the pictures. Each group of picture may include at least two pictures.

Generally, similar pictures may be generated when the terminal photographs the same content continuously, or photographs the same content for many times within a period of time, or captures a plurality of screenshots of the same area on the screen using a snipping tool within a certain period of time. Such similar pictures generally have the same attribute information. Based on a difference in the attributes, the terminal may divide the pictures in the picture directory into groups of pictures. Each of the groups of pictures may include at least two pictures.

The terminal may divide the pictures in the picture directory into groups of pictures according to a difference in the information on the attributes in ways as follows.

In one or more embodiments, the terminal may classify, according to the photographing time, pictures photographed in the same period of time into the same group of pictures. For example, a picture A has been photographed at 10:00:00, May 1, 2015; a picture B has been photographed at 10:00:20, May 1, 2015; a picture C has been photographed at 10:00:54, May 1, 2015; a picture D has been photographed at 12:20:10, May 10, 2015; and a picture E has been photographed at 12:20:56, May 10, 2015; then pictures A, B, and C may be classified into one group of pictures, and pictures D and E may be classified into one group of pictures.

According to one or more embodiments, the terminal may classify, according to a photographing location, pictures photographed at the same location into the same group of pictures. For example, a picture A has been photographed at Tiananmen; a picture B has been photographed at the Forbidden City; a picture C has been photographed at the Forbidden City; a picture D has been photographed at the National Stadium; a picture E has been photographed at the National Stadium; and a picture F has been photographed at the Forbidden City; then pictures B, C, and F may be classified into one group of pictures, and pictures D and E may be classified into one group of pictures.

In a practical application, besides division according to the photographing time and the photographing location of each picture, the pictures in the picture directory may also be divided into groups of pictures according to a pixel number, a brightness, a contrast, a grey scale, and/or the like. Of course, the aforementioned conditions may also be combined in any form. In other words, the pictures in the picture directory may be divided according to at least two of the conditions. A combination thereof will not be elaborated in one or more embodiments.

In step 2, the terminal may compute a similarity of global features of two pictures in a group of pictures and a similarity of local features of the two pictures.

Generally, a global feature of a picture consists of feature values of key points at different positions. In computing the similarity of global features of two pictures, an Euclidean distance between feature values at the same position on the two pictures may be computed. After computation has been done for feature values at all the positions, the terminal will count a number of feature values with Euclidean distances smaller than a preset value, and then compute a proportion of the number of the feature values with Euclidean distances smaller than the preset value in all feature values involved in the commutation. The proportion is the similarity of the global features.

In practical computation, besides computing an Euclidean distance between global features of the two pictures, a cosine distance between global features of the two pictures may also be computed. Of course, other methods may also be adopted, which will not be described one by one herein.

The similarity of the local features of two pictures may also be computed in a way similar to that for computing the similarity of the global features. Refer to computing the similarity of the global features for a specific computing principle thereof, which will not be repeated here.

When the similarity of the global features is greater than a first threshold, and the similarity of the local features is greater than a second threshold, a weighted result may be obtained by weighting the similarity of the global features and the similarity of the local features according to weights preset for the similarity of the global features and the similarity of the local features. When the weighted result is greater than a third threshold, the two pictures may be set to be similar pictures that are similar to each other. The first threshold may be 60%, 70% and/or the like. The second threshold may be 50%, 65% and/or the like. The third threshold may be 40%, 63% and/or the like. Values of the first threshold, the second threshold, and the third threshold are not limited by the present embodiment. The first, second, and third threshold may be empirical values or may be determined based on statistics or any other method available to one of ordinary skill in the art. The present disclosure does not intend to limit the means of determining the first, second, and third threshold values. In one example, in order to set a first, second and third thresholds, sample pictures are collected. Some of the sample pictures are similar and belong to the same group of similar pictures. Through computing the similarity of the global features and the local features of the sample pictures, the first threshold, the second threshold and the third threshold are determined.

The values of the first threshold, the second threshold, and the third threshold are examples only and are not intended for limiting the thresholds.

In step 3, the terminal may form a group of similar pictures with a plurality of pictures similar to a same picture in the group of pictures.

After comparison has been performed in the aforementioned way on a plurality of pictures in a group of pictures, a relationship between any two pictures in a group of pictures may be determined. In this case, a group of similar pictures may be formed with a plurality of pictures similar to a same picture in the group of pictures. For example, there are five pictures A, B, C, D, and E in a group of pictures. When pictures A and B are similar pictures, pictures B and C are similar pictures, pictures A and C are not similar pictures, pictures A and D are not similar pictures, pictures B and D are not similar pictures, and pictures D and E are similar pictures, then a group of similar pictures may be formed with pictures A, B, and C, and a group of similar pictures may be formed with pictures D and E.

In step 205, the terminal displays pictures group by group. The terminal may display pictures in each group of similar pictures in units of groups of similar pictures in an order of photographing time.

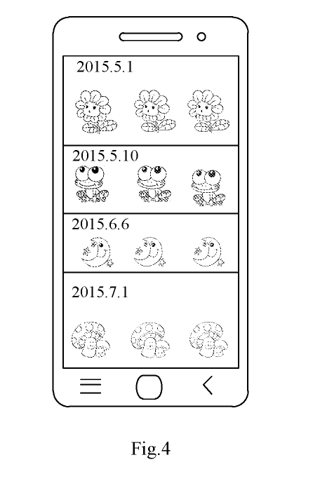

After the pictures in the picture directory have been divided into groups of similar pictures, to facilitate processing pictures in a group of similar pictures, the terminal may further display pictures in each group of similar pictures in units of groups of similar pictures according to the photographing time. The terminal may perform the displaying in chronological order of the photographing time or in reverse chronological order of the photographing time. For example, FIG. 4 shows pictures in a group of similar pictures displayed in reverse chronological order of the photographing time.

In step 206, the terminal processes a picture in each group of similar pictures according to a detected operation.

To facilitate processing each picture, the terminal may further display a save option and a delete option on each picture of each group of similar pictures. The save option or the delete option may be in form of a menu or a button. The form of the save option or the delete option is not limited by the present embodiment. When a plurality of pictures are displayed according to a time sequence in clusters of similar pictures, the user may view these pictures rapidly. The terminal may detect an operation of the user and process pictures in each group of similar pictures. When it is detected that a delete option on a picture is selected, the terminal will delete the picture. When it is detected that a save option on a picture is selected, the terminal will save the picture.

Generally, to prevent a picture stored in the terminal from being lost, the user may further back up a picture in the terminal on a cloud memory of a server. Therefore, after the terminal has deleted a picture and managed the memory space per se, the terminal may further send a delete instruction to the server. The delete instruction may be configured for instructing the server to delete the corresponding picture in a cloud memory space to manage the cloud memory space of the server.

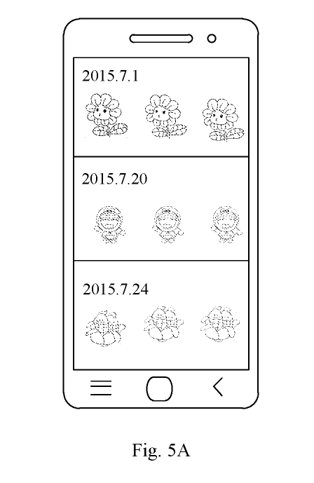

After pictures in a group of similar pictures are processed in this way, when the user saves only one picture in the group of similar pictures, the one picture will not be displayed the next time a group of similar pictures is to be displayed. When some similar pictures have been added in the terminal, the added pictures may be displayed together with pictures in an original group of similar pictures next time when pictures in a group of similar pictures are to be managed. When the terminal displays pictures in a group of similar pictures in chronological order of the photographing time, the added group of similar pictures may be displayed after a group of similar pictures saved by the user, as shown in FIG. 5A. When the terminal displays pictures in a group of similar pictures in reverse chronological order of the photographing time, then the added group of similar pictures will be displayed before a group of similar pictures saved by the user, as shown in FIG. 5B.

With a method according to one or more embodiments, a picture is grouped into a group of similar pictures according to attributes of the pictures such as photographing time and picture features of the pictures; pictures are then displayed by groups of similar pictures according to the photographing time, thus facilitating processing, by a user, a picture in a group of similar pictures with a more convenient and less time consuming processing process.

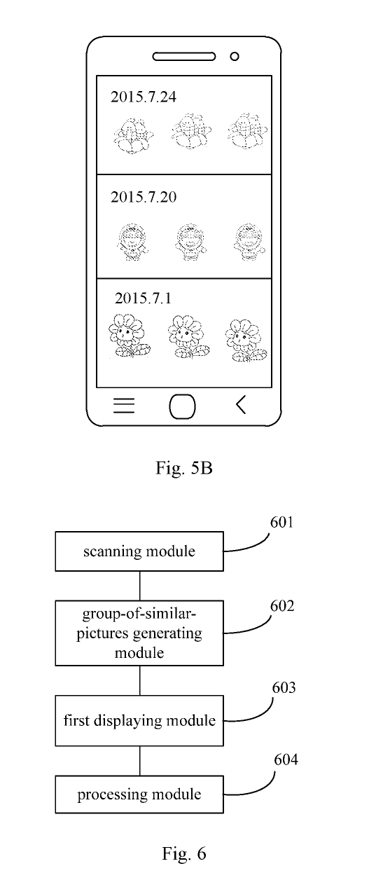

FIG. 6 is a diagram of a picture processing device according to an exemplary embodiment. Referring to FIG. 6, the device includes: a scanning module 601, a group-of-similar-pictures generating module 602, a first displaying module 603, and a processing component 604.

The scanning module 601 is configured for: during memory space management, scanning a plurality of pictures in a picture directory.

The group-of-similar-pictures generating module 602 is configured for: generating at least one group of similar pictures according to information on an attribute of each picture and pre-extracted picture features of the each picture. The information on the attribute may include at least a photographing time.

The first displaying module 603 is configured for: displaying pictures in each group of similar pictures in units of groups of similar pictures in an order of photographing time.

The processing component 604 is configured for: processing a picture in each group of similar pictures according to a detected operation.

According to one or more embodiments, the picture features may include a global feature and a local feature.

The group-of-similar-pictures generating module 602 is configured for: dividing the pictures in the picture directory into groups of pictures, each of the groups of pictures including at least two pictures; computing a similarity of global features of two pictures in a group of pictures and a similarity of local features of the two pictures; when the similarity of the global features is greater than a first threshold, and the similarity of the local features is greater than a second threshold, obtaining a weighted result by weighting the similarity of the global features and the similarity of the local features; when the weighted result is greater than a third threshold, setting the two pictures to be similar pictures that are similar to each other; and forming a group of similar pictures with a plurality of pictures similar to a same picture in the group of pictures.

According to one or more embodiments, the processing module 604 may be configured for: displaying a save option and a delete option on each picture of each group of similar pictures; when it is detected that a delete option on a picture is selected, deleting the picture; when it is detected that a save option on a picture is selected, saving the picture.

According to one or more embodiments, the device may further include a sending module.

The sending module may be configured for: sending a delete instruction to a server, wherein the delete instruction is configured for instructing the server to delete the picture in a cloud memory space.

According to one or more embodiments, the device may further include a second displaying module.

The second displaying module may be configured for: displaying a picture management option on a memory space management page.

The scanning module 601 may be configured for: when it is detected that the picture management option is selected, scanning a plurality of pictures in the picture directory.

A device according to one or more embodiments, a picture is grouped into a group of similar pictures according to attributes of the pictures such as photographing time and picture features of the pictures; pictures are then displayed by groups of similar pictures according to the photographing time, thus facilitating processing, by a user, a picture in a group of similar pictures with a more convenient and less time consuming processing process.

With respect to the devices in the above embodiments, the specific manners for performing operations for individual modules therein have been described in detail in the embodiments regarding picture processing methods, which will not be elaborated herein.

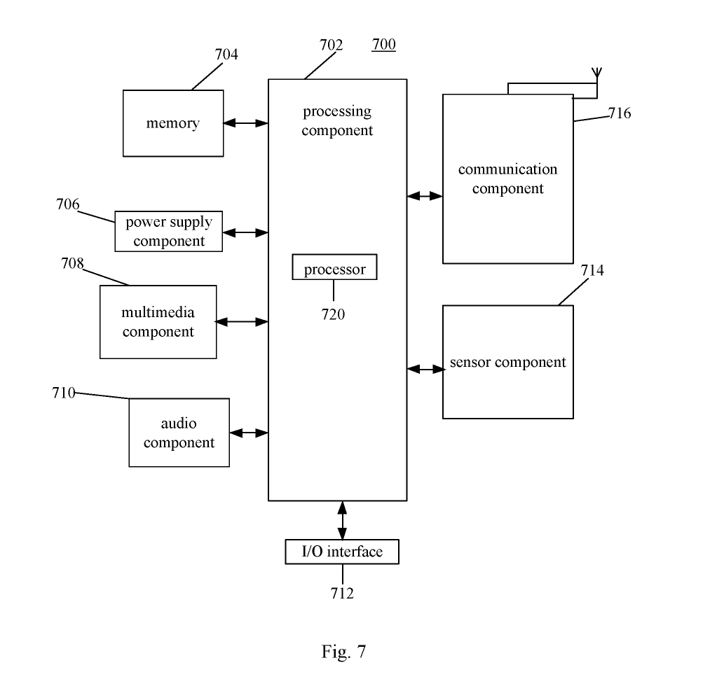

FIG. 7 is a block diagram of a picture processing device 700 according to an exemplary embodiment. For example, the device 700 may be a terminal device such as a mobile phone, a computer, a digital broadcasting terminal, a message transceiver, a game console, a tablet device, a medical device, a fitness device, a personal digital assistant, and/or the like.

Referring to FIG. 7, the device 700 may include one or more components as follows: a processing component 702, a memory 704, a power supply component 706, a multimedia component 708, an audio component 710, an Input/Output (I/O) interface 712, a sensor component 714, and a communication component 716.

Generally, the processing component 702 controls an overall operation of the device 700, such as operations associated with display, a telephone call, data communication, a camera operation and a recording operation. The processing component 702 may include one or more processors 720 to execute instructions so as to complete all or some steps of the method. In addition, the processing component 702 may include one or more modules to facilitate interaction between the processing component 702 and other components. For example, the processing component 702 may include a multimedia module to facilitate interaction between the multimedia component 708 and the processing component 702.

The memory 704 may be configured for storing various types of data to support the operation on the terminal 700. Example of such data may include instructions of any application or method operating on the device 700, contact data, phonebook data, messages, pictures, videos, and the like. The memory 704 may be realized by any type of volatile or non-transitory storage equipment or combination thereof, such as Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic memory, flash memory, magnetic disk, or compact disk.

The power supply component 706 may supply electric power to various components of the device 700. The power supply component 706 may include a power management system, one or more power sources, and other components related to generating, managing and distributing electricity for the device 700.

The multimedia component 708 may include a screen providing an output interface between the device 700 and a user. In some embodiments, the screen may include a Liquid Crystal Display (LCD) and a Touch Panel (TP). If the screen includes a TP, the screen may be realized as a touch screen to receive an input signal from a user. The TP may include one or more touch sensors for sensing touch, slide and gestures on the TP. The touch sensors not only may sense the boundary of a touch or slide move, but also detect the duration and pressure related to the touch or slide move. In some embodiments, the multimedia component 708 may include a front camera and/or a rear camera. When the device 700 is in operation, for example a shooting mode or a video mode, the front camera and/or the rear camera may receive external multimedia data. Each of the front camera and the rear camera may be a fixed optical lens system or may have a focal length and be capable of optical zooming.

The audio component 710 may be configured for outputting and/or inputting an audio signal. For example, the audio component 710 may include a microphone (MIC). When the device 700 is in an operation mode such as a call mode, a recording mode, and a voice recognition mode, the MIC may be configured for receiving an external audio signal. The received audio signal may be further stored in the memory 704 or may be sent via the communication component 716. In some embodiments, the audio component 710 may further include a loudspeaker configured for output the audio signal.

The I/O interface 712 may provide an interface between the processing component 702 and a peripheral interface module. Such a peripheral interface module may be a keypad, a click wheel, a button or the like. Such a button may include but is not limited to: a homepage button, a volume button, a start button, and a lock button.

The sensor component 714 may include one or more sensors for assessing various states of the device 700. For example, the sensor component 714 may detect an on/off state of the device 700 and relative positioning of components such as the display and the keypad of the device 700. The sensor component 714 may also detect change in the position of the device 700 or of a component of the device 700, whether there is contact between the terminal and a user, the orientation or acceleration/deceleration of the device 700, and change in the temperature of the device 700. The sensor component 714 may include a proximity sensor configured for detecting existence of a nearby object without physical contact. The sensor component 714 may also include an optical sensor such as a Complementary Metal-Oxide-Semiconductor (CMOS) or Charge-Coupled-Device (CCD) image sensor used in an imaging application. In some embodiments, the sensor component 714 may also include an acceleration sensor, a gyroscope sensor, a magnetic sensor, a pressure sensor, or a temperature sensor.

The communication component 716 may be configured for facilitating wired or wireless communication between the device 700 and other equipment. The device 700 may access a wireless network based on a communication standard such as WiFi, 2G or 3G or combination thereof. In an exemplary embodiment, the communication component 716 may receive a broadcast signal or broadcast related information from an external broadcast management system via a broadcast channel. In an exemplary embodiment, the communication component 716 may also include a Near Field Communication (NFC) module for short-range communication. For example, the NFC module may be based on Radio Frequency Identification (RFID), Infrared Data Association (IrDA), Ultra-Wideband (UWB) technology, Bluetooth (BT), and other technologies.

In an exemplary embodiment, the device 700 may be realized by one or more of Application Specific Integrated Circuits (ASIC), Digital Signal Processors (DSP), Digital Signal Processing Device (DSPD), Programmable Logic Devices (PLD), Field Programmable Gate Arrays (FPGA), controllers, microcontrollers, microprocessors or other electronic components to implement the method. Each module, such as discussed with respect to FIG. 6, may take the form of a packaged functional hardware unit designed for use with other components, a portion of a program code (e.g., software or firmware) executable by the processor 720 or the processing circuitry that usually performs a particular function of related functions, or a self-contained hardware or software component that interfaces with a larger system, for example.

In an exemplary embodiment, a non-transitory computer-readable storage medium including instructions, such as a memory 704 including instructions, may be provided. The instructions may be executed by the processor 720 of the device 700 to implement the method. For example, the non-transitory computer-readable storage medium may be a Read-Only Memory (ROM), a Compact Disc Read-Only Memory (CD-ROM), a magnetic tape, a floppy disk, optical data storage equipment, etc.

A non-transitory computer readable storage medium enables a mobile terminal to execute a picture processing method when instructions in the storage medium are executed by a processor of the mobile terminal. The method includes steps as follows.

During memory space management, a plurality of pictures in a picture directory are scanned. At least one group of similar pictures is generated according to information on an attribute of each picture and pre-extracted picture features of the each picture. The information on the attribute may include at least a photographing time. Pictures in each group of similar pictures are displayed in units of groups of similar pictures in an order of photographing time. A picture in each group of similar pictures is processed according to a detected operation.

According to one or more embodiments herein, the picture features may include a global feature and a local feature. At least one group of similar pictures may be generated according to the information on the attributes of the pictures and the pre-extracted picture features of the pictures as follows. The pictures in the picture directory may be divided into groups of pictures. Each of the groups of pictures may include at least two pictures.

A similarity of global features of two pictures in a group of pictures and a similarity of local features of the two pictures may be computed. When the similarity of the global features is greater than a first threshold, and the similarity of the local features is greater than a second threshold, a weighted result may be obtained by weighting the similarity of the global features and the similarity of the local features. When the weighted result is greater than a third threshold, the two pictures may be set to be similar pictures that are similar to each other. A group of similar pictures may be formed with a plurality of pictures similar to a same picture in the group of pictures.

According to one or more embodiments, a picture in a group of similar pictures may be processed according to a detected operation as follows.

A save option and a delete option may be displayed on a picture of a group of similar pictures.

When it is detected that a delete option on a picture is selected, the picture may be deleted.

When it is detected that a save option on a picture is selected, the picture may be saved.

According to one or more embodiments, after a picture is deleted, a delete instruction may be sent to a server.

The delete instruction may be configured for instructing the server to delete the picture in a cloud memory space.

According to one or more embodiments, the method may further include steps as follows.

A picture management option may be displayed on a memory space management page.

When it is detected that the picture management option is selected, a plurality of pictures in the picture directory may be scanned.

With a non-transitory computer readable storage medium according to one or more embodiments, a picture is grouped into a group of similar pictures according to attributes of the pictures such as photographing time and picture features of the pictures; pictures are then displayed by groups of similar pictures according to the photographing time, thus facilitating processing, by a user, a picture in a group of similar pictures with a more convenient and less time consuming processing process.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

1. A picture processing method, comprising:
scanning, by a device, a plurality of pictures in a picture directory in the memory storage during a process to manage the memory storage;
generating, by the device, at least one group of similar pictures according to an attribute of each picture and pre-extracted picture features of the each picture, wherein the attribute comprises at least a photographing time;
displaying, by the device, pictures group by group; and
detecting, by the device, an operation on at least one picture and processing the at least one picture according to the detected operation.

2. The method according to claim 1, wherein the pre-extracted picture features comprises a global feature and a local feature;
the generating at least one group of similar pictures according to the attribute of each picture and the pre-extracted picture features of the each picture comprises:
dividing the pictures in the picture directory into groups of pictures according to the attribute of the each picture, wherein each of the groups of pictures comprises at least two pictures;
computing a similarity of global features of two pictures in a group of pictures and a similarity of local features of the two pictures;
when the similarity of the global features is greater than a first threshold, and the similarity of the local features is greater than a second threshold, obtaining a weighted result by weighting the similarity of the global features and the similarity of the local features;
when the weighted result is greater than a third threshold, setting the two pictures to be similar pictures similar to each other; and
generating a group of similar pictures including pictures similar to a same picture in the group of pictures.

3. The method according to claim 1, wherein detecting an operation on at least one picture and processing the at least one picture according to the detected operation comprises:
displaying a save option and a delete option on each picture of each group of similar pictures;
when detecting that a delete option on the at least one picture is selected, deleting the picture;
when detecting that a save option on the at least one picture is selected, saving the picture.

4. The method according to claim 3, further comprising: after the deleting the picture,
sending a delete instruction to a server, wherein the delete instruction instructs the server to delete a corresponding picture in a cloud memory space.

5. The method according to claim 1, further comprising:
displaying a picture management option on a memory space management page; and
when detecting that the picture management option is selected, starting the scanning of the plurality of pictures in the picture directory.

6. A picture processing device, comprising:
a processor; and
a memory, configured for: storing an instruction executable by the processor,
wherein the processor is configured to:
scan a plurality of pictures in a picture directory in the memory during a process to manage the memory;
generate at least one group of similar pictures according to an attribute of each picture and pre-extracted picture features of the each picture, wherein the attribute comprises at least a photographing time;
display pictures group by group; and
detect an operation on at least one picture and processing the at least one picture according to the detected operation.

7. The device according to claim 6, wherein the pre-extracted picture features comprises a global feature and a local feature and the processor is further configured to:
divide the pictures in the picture directory into groups of pictures according to the attribute of the each picture, wherein each of the groups of pictures comprises at least two pictures;
compute a similarity of global features of two pictures in a group of pictures and a similarity of local features of the two pictures;
when the similarity of the global features is greater than a first threshold, and the similarity of the local features is greater than a second threshold, obtain a weighted result by weighting the similarity of the global features and the similarity of the local features;
when the weighted result is greater than a third threshold, set the two pictures to be similar pictures similar to each other; and
generate a group of similar pictures with including pictures similar to a same picture in the group of pictures.

8. The device according to claim 6, wherein the processor is further configured to:
display a save option and a delete option on each picture of each group of similar pictures;
when detecting that a delete option on a picture is selected, delete the picture;
when detecting that a save option on a picture is selected, save the picture.

9. The device according to claim 8, wherein the processor is further configured to:
after the deleting the picture,
send a delete instruction to a server, wherein the delete instruction instructs the server to delete a corresponding picture in a cloud memory space.

10. The device according to claim 1, wherein the processor is further configured to:
display a picture management option on a memory space management page; and
when detecting that the picture management option is selected, start the scanning of the plurality of pictures in the picture directory.

11. A non-transitory computer-readable storage medium having stored therein instructions that, when executed by a processor, causes the processor to perform acts comprising:
scanning a plurality of pictures in a picture directory in the memory storage during a process to manage the memory storage;
generating at least one group of similar pictures according to an attribute of each picture and pre-extracted picture features of the each picture, wherein the attribute comprises at least a photographing time;
displaying pictures group by group; and
detecting an operation on at least one picture and processing the at least one picture according to the detected operation.

12. The storage medium according to claim 11, wherein the picture features comprises a global feature and a local feature;
the generating at least one group of similar pictures according to information on an attribute of each picture and the pre-extracted picture features of the each picture comprises:
dividing the pictures in the picture directory into groups of pictures according to the information on the attribute of the each picture, wherein each of the groups of pictures comprises at least two pictures;
computing a similarity of global features of two pictures in a group of pictures and a similarity of local features of the two pictures;
when the similarity of the global features is greater than a first threshold, and the similarity of the local features is greater than a second threshold, obtaining a weighted result by weighting the similarity of the global features and the similarity of the local features;
when the weighted result is greater than a third threshold, setting the two pictures to be similar pictures similar to each other; and
generating a group of similar pictures with including pictures similar to a same picture in the group of pictures.

13. The storage medium according to claim 11, wherein the processing a picture in each group of similar pictures according to a detected operation comprises:
displaying a save option and a delete option on each picture of each group of similar pictures;
when it is detected that a delete option on a picture is selected, deleting the picture;
when it is detected that a save option on a picture is selected, saving the picture.

14. The storage medium according to claim 13, wherein the method further comprises:
after the deleting the picture,
sending a delete instruction to a server, wherein the delete instruction instructs the server to delete a corresponding picture in a cloud memory space.

15. The storage medium according to claim 11, wherein the method further comprises:
displaying a picture management option on a memory space management page; and
when detecting that the picture management option is selected, start scanning the plurality of pictures in a picture directory.
